(19) United States
(12) Patent Application Publication
(10) Pub. No.: US 2025/0072387 A1
(43) Pub. Date: Mar. 6, 2025

(54) Dog urine pad

(71) Applicant: Paco van Meer, Austin, TX (US)

(72) Inventor: Paco van Meer, Austin, TX (US)

(21) Appl. No.: 18/240,353

(22) Filed: Aug. 31, 2023

(51) Int. Cl. A01K 1/015; A61F 13/42

(52) U.S. Cl. CPC A01K 1/0157; G01N 21/80

(57) ABSTRACT

According to an aspect of the present invention, there is provided there is provided a dog pee pad, comprising: two or more layers; pulp dispersed between the layers; a pH indicator; and a polyethylene bottom. According to another aspect of the present invention, there is provided a method, comprising: of assessing the health of a dog, comprising: training a dog to pee on a pee pad; obtaining a sample of dog urine on the pee pad; waiting for the reaction of the sample with compounds in the pee pad; comparing the color indicated by the reaction with a color scale; and correlating the color scale to a chart of indicated health conditions.

### BACKGROUND

Some dog owners may wish to train a dog to go potty on a designated potty pad instead of outdoors like typical potty training. Replaceable absorbent pads have been disclosed in the prior art for this purpose and have been known to be useful for caring for and training dogs living in indoor environments like apartments, condominiums, townhomes, dorm rooms and the like.

Dog owners with large outdoor yards in which their dogs can spend the majority of their time outside and are trained to go potty outside may wish also to monitor and measure the health of their dog and may be able to get their dog to go potty on a pad one time or repeatedly.

### SUMMARY OF INVENTION

Accordingly, the present invention provides an improved pad for receiving dog urine.

According to an aspect of the present invention, there is provided a dog pee pad, comprising: two or more layers; pulp dispersed between the layers; a pH indicator; and a polyethylene bottom.

According to another aspect of the present invention, there is provided a method, comprising: of assessing the health of a dog, comprising: training a dog to pee on a pee pad; obtaining a sample of dog urine on the pee pad; waiting for the reaction of the sample with compounds in the pee pad; comparing the color indicated by the reaction with a color scale; and correlating the color scale to a chart of indicated health conditions.

### BRIEF DESCRIPTION OF THE DRAWINGS

FIG. 1 shows a color scale for a health-indicating dog pee pad according to an embodiment of the present invention;

FIG. 2 shows a chart for interpreting the results of a sample dispersed on a health-indicating dog pee pad according to an embodiment of the present invention; and

FIG. 3 illustrates a dog pee pad according to an embodiment of the present invention.

### DETAILED DESCRIPTION

Solutions for early detection of diseases in dogs can be implemented in a pee pad which obviates the need for a dog urine sample to be collected, e.g., in a cup, which is difficult and inconvenient for a pet owner. A dog pee pad can contain compounds that change color in reaction to dog urine. A color chart can be provided to help an owner interpret the color change.

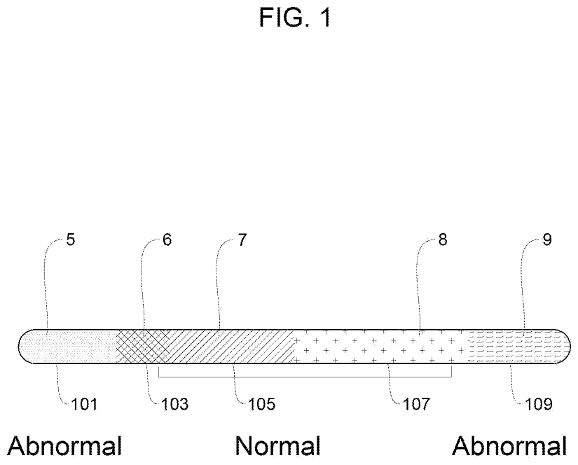

FIG. 1 shows a color scale for a health-indicating dog pee pad according to an embodiment of the present invention.

For example, a dog pee pad can be white in color. If the pee pad turns yellow when it comes in contact with the urine of a dog, it can indicate that the dog is healthy. However, if the litter turns to a color other than yellow, e.g., green, orange, it can indicate that the dog has some illness, while another color, e.g., red, dark pink, purple, can indicate that the dog has a medical condition other than an illness, such as pregnancy. The dog can then be taken to a veterinary doctor for further diagnosis. In some embodiments, the chemical agent in the pee pad is made such that it turns to the color of the urine if the dog does not have any illness or other medical condition resulting in an abnormal urine pH.

In the example of FIG. 1, a color scale is given on a pH scale. pH region 5 corresponds with a dog urine pH of 5-6, pH region 6 corresponds with a dog urine pH of 6-7, pH region 7 corresponds with a dog urine pH of 7-8, pH region 8 corresponds with a dog urine pH of 8-9, and pH region 9 corresponds with a dog urine pH of 9-10.

Color 101 indicates an abnormally acidic pH. Color 103 indicates a possibly abnormally acidic pH, but could also correspond to a normal pH. Color 105 indicates a normal pH. Color 107 indicates a probably normal pH, but could also correspond to an abnormally basic pH. Color 109 indicates an abnormally basic pH.

Dog urine must have a particular pH to maintain urinary tract health. Although the healthy range varies, generally from 6.8 to 8.5 may be considered normal. A pH of dog urine above this range may indicate a bacterial infection affecting the dog.

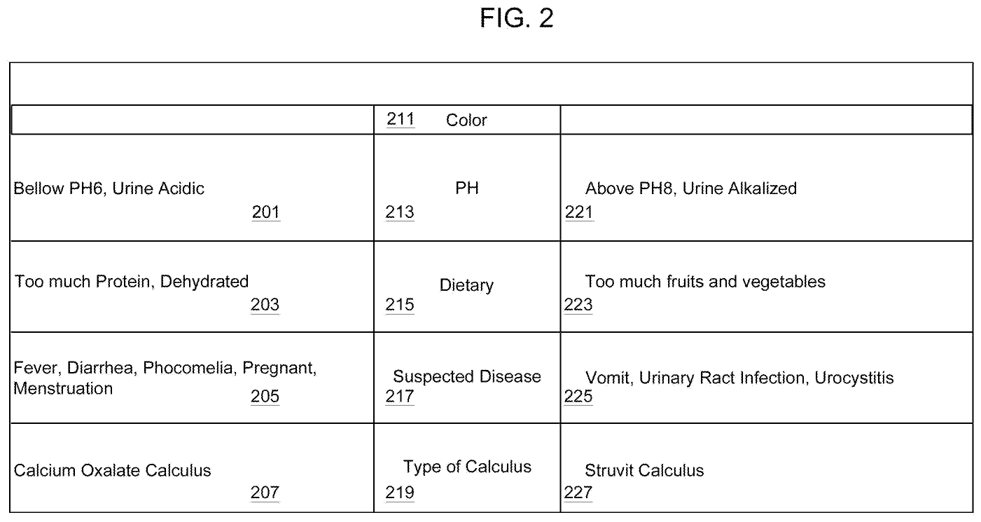

FIG. 2 shows a chart for interpreting the results of a sample dispersed on a health-indicating dog pee pad according to an embodiment of the present invention.

Color 211 indicates color coding for results 201-207 and 221-227 for test metrics 213-219. Test metric 213 is a urine pH of the dog providing the urine sample on the pee pad. Test metric 215 is a measure of dietary health of the dog. Test metric 217 indicates specific diseases based on the urine sample. Test metric 219 indicates types of calculus found in the urine.

Result 201 of test metric 213 indicates the urine sample provided by the dog has a pH below 6 and is abnormally acidic. Result 221 indicates the urine sample provided by the dog has a pH above 8 and is abnormally basic.

Result 203 of test metric 215 indicates the urine sample provided by the dog has corresponds to a dehydrated dog or a dog consuming too much protein. Result 223 indicates the urine sample provided by the dog has corresponds to a dog consuming too much fruit and/or vegetables.

Result 205 of test metric 217 indicates the urine sample provided by the dog has corresponds to a pregnant or menstruating dog or a dog with fever, diarrhea, or phocomelia. Result 225 indicates the urine sample provided by the dog has corresponds to a dog suffering from vomiting, urinary tract infection, or urocystitis.

Result 207 of test metric 219 indicates the urine sample provided by the dog has contains calcium oxalate calculus. Result 227 indicates the urine sample provided by the dog contains struvite calculus.

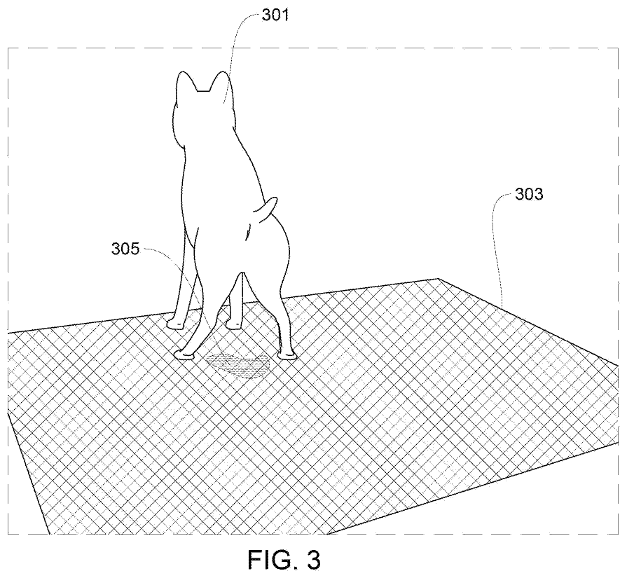

FIG. 3 illustrates a dog pee pad according to an embodiment of the present invention.

Dog 301 is trained to stand atop pee pad 303 or otherwise placed upon pee pad 303 to give a urine sample. Pee pad 303 can be a wide variety of lengths and widths.

Dog urine sample 305 is obtained on pee pad 303 and may react as described above with reference to FIG. 1 and FIG. 2 to indicate the presence, absence, or characteristics of compounds in the dog urine correlated with one or more health states of the dog.

Pee pad 303 can be comprised of six layers (for example), pulp dispersed between the layers, a pH indicator and a polyethylene bottom. The layers can comprise fabrics, plastics, paper, or a variety of other materials.

The pulp and the layers may contain various natural or synthetic absorbent materials, such as cellulose fibers, wood pulp fibers, regenerated cellulose or cotton fibers, a blend of pulp and other fiber, or the like, or combinations thereof. One such material is a material which is composed of a mixture of cellulosic fibers and synthetic polymer fibers.

Pulp can comprise cellulose made from a variety of trees or plants. For example, bamboo pulp material can also be used as a pulp filling for the pad by itself or mixed with any other various pulp materials common in the art.

Various additives may be introduced into the pad for purposes of indicating the health of the dog providing the urine sample and to provide other desired properties. For example, an attractant for a dog, a deodorizer (e.g., cedar particles), and/or a disinfectant may be provided. These additives may be incorporated in a variety of manners into one or more layers of dog pee pad 303.

An owner can utilize pee pad 303 for example by training a dog to pee on a pee pad; obtaining a sample of dog urine on the pee pad; waiting for the reaction of the sample with compounds in the pee pad; comparing the color indicated by the reaction with a color scale; and correlating the color scale to a chart of indicated health conditions.

The chart of indicated health conditions can contains information about the diet of the dog providing the urine sample. An owner can then adjust the diet of the dog providing the urine sample based on the color scale and correlated information on the chart of indicated health conditions.

What is claimed is:

1. A dog pee pad, comprising:
two or more layers;
pulp dispersed between the layers;
a pH indicator, and
a polyethylene bottom.

2. The dog pee pad of claim 1, further comprising a compound configured to indicate the presence of albumin.

3. The dog pee pad of claim 1, further comprising a compound configured to indicate the presence of blood.

4. The dog pee pad of claim 1, further comprising an antibacterial compound.

5. The dog pee pad of claim 1, further comprising an accompanying color scale for assessing a urine sample obtained on the pad.

6. The dog pee pad of claim 5, further comprising a chart containing health conditions indicated by the color scale.

7. The dog pee pad of claim 7, wherein the chart indicates information about the diet of the dog providing the urine sample.

8. A method of assessing the health of a dog, comprising:
training a dog to pee on a pee pad;
obtaining a sample of dog urine on the pee pad;
waiting for the reaction of the sample with compounds in the pee pad;
comparing the color indicated by the reaction with a color scale; and
correlating the color scale to a chart of indicated health conditions.

9. The method of claim 8, wherein the chart of indicated health conditions contains information about the diet of the dog providing the urine sample.

10. The method of claim 9, further comprising adjusting the diet of the dog providing the urine sample based on the color scale and correlated information on the chart of indicated health conditions.
